(19) United States
(12) Patent Application Publication
(10) Pub. No.: US 2017/0060666 A1
(43) Pub. Date: Mar. 2, 2017

(54) CONTROLLER CAPABLE OF DETECTING FACTOR AT TIME OF ABNORMALITY OF PC FUNCTION

(71) Applicant: FANUC CORPORATION, Minamitsuru-gun (JP)

(72) Inventor: Yasuharu Aizawa, Minamitsuru-gun (JP)

(73) Assignee: FANUC CORPORATION, Minamitsuru-gun (JP)

(21) Appl. No.: 15/245,303

(22) Filed: Aug. 24, 2016

(30) Foreign Application Priority Data
Aug. 27, 2015 (JP) 2015-167685

(51) Int. Cl. G06F 11/07; G06F 11/36

(52) U.S. Cl. CPC G06F 11/0757; G06F 11/3632; G06F 11/0721

(57) ABSTRACT

Provided is a controller capable of performing discrimination as to whether abnormality is caused by a hardware factor or a software factor according to an output state of a signal at the time of occurrence of the abnormality. The controller has a PC function and includes a hardware timer configured with only hardware and a software timer performing counting by software, and the controller generates a signal indicating that a hardware timer is working and a signal indicating that a software timer is working and outputs these signals.

### BACKGROUND OF THE INVENTION

1. Field of the Invention

The present invention relates to a controller capable of performing discrimination as to whether abnormality is caused by a hardware factor or a software factor according to an output state of a signal at the time of occurrence of the abnormality.

2. Description of the Related Art

In a case where abnormality occurs in a PC function due to a problem in application or hardware, in many cases, display itself is not updated, and thus, the factor thereof is not easily detected,

At the time of occurrence of failure, generally, since no information can be obtained, by performing activation again, individual applications are operated actually, and the applications are checked one by one, so that factors of occurrence of failure are detected. However, in some cases, reproduction cannot be obtained even by doing so, and thus, in many cases, the factor of the occurrence of a failure of previous time are unknown. In addition, even though the reproduction can be obtained, it is not easy to determine whether the failure is caused by a hardware facture or by a specific application.

A technique of a watch dog timer that detects whether or not a program is operated normally is disclosed in JP 01-320549 A. However, this technique is for operating the watch dog timer that is configured to prevent a runaway of a CPU even if there is abnormality in any one of hardware and software. The technique does not have a function of detecting which one of a software factor and a hardware factor the abnormality is caused by

### SUMMARY OF THE INVENTION

An object of the invention is, in view of the above, to provide a controller capable of performing discrimination as to whether abnormality is caused by a hardware factor or a software factor according to an output state of a signal at the time of occurrence of the abnormality.

The controller of the invention has a PC function and includes: a hardware timer that is configured with only hardware; a software timer that performs counting by software; a hardware timer during-startup signal generation unit that generates a hardware timer during-startup signal indicating that the hardware timer is in a state during startup; a software timer during-startup signal generation unit that generates a software timer during-startup signal indicating that the software timer is in a state during startup; and an output unit that outputs a state of the hardware timer during-startup signal and a state of the software timer during-startup signal.

A plurality of the software timers may be provided in accordance with priority, and each of the software timers includes the software timer during-startup signal generation unit.

According to the invention, provided is a controller capable of performing discrimination as to whether abnormality is caused by a hardware factor or a software factor according to an output state of a signal at the time of occurrence of the abnormality, in addition, in a case where a software timer is prepared for every level of priority, even in a case where abnormality is caused by a software factor, it can be identified by the controller which level is the priority of the application were the abnormality occurs.

### BRIEF DESCRIPTION OF THE DRAWINGS

The forgoing and other objects and feature of the invention will be apparent from the following description of preferred embodiments of the invention with reference to the accompanying drawings, in which:

FIG. 1 is a schematic diagram illustrating a configuration of a controller according to an embodiment of the invention;

FIG. 2 is a functional block diagram illustrating an operation. state of the controller of FIG. 1;

FIG. 3 is a diagram illustrating a startup sequence of the controller illustrated in FIGS. 1 and 2.

FIG. 4 is a diagram illustrating an operation state when hardware abnormality occurs during operation of the controller illustrated in FIGS. 1 and 2;

FIG. 5 is a diagram illustrating an operation state when abnormality occurs in an application of a level of priority 1 during operation of the controller illustrated in FIGS. 1 and 2; and

FIG. 6 is a diagram illustrating an operation state when abnormality occurs in an application of a level of priority 2 during operation of the controller illustrated in FIGS. 1 and 2.

### DETAILED DESCRIPTION OF THE PREFERRED EMBODIMENTS

The controller according to the invention uses a hardware timer and a software timer to notifies the outside of the fact that the numerical controller is in an operation by using display output such as a signal or an LED. At the time of occurrence of abnormality, discrimination as to whether the abnormality is caused by a hardware factor or a software factor is performed according to such an output state

In addition, generally, each application is designated to a priority of execution. A high-priority application is executed with priority, and in a case where some abnormality occurs in the high-priority application, a low-priority application waits for the execution. In the invention, by using software timers executing with different levels of priority, even in a case where abnormality is caused by a software factor, it can be identified which level is the priority of the application where the abnormality occurs.

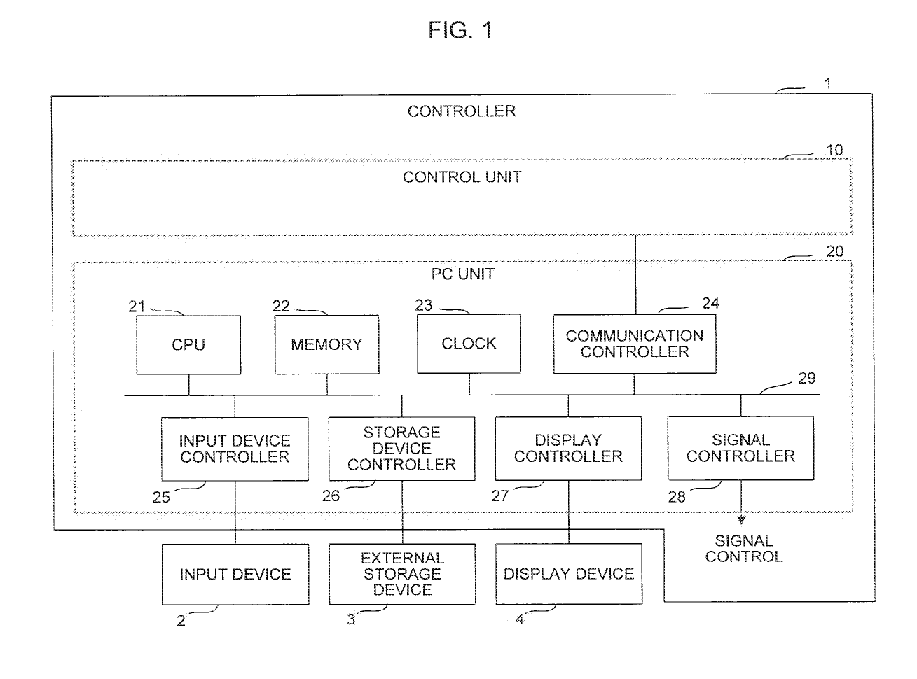

A configuration of the controller according to the embodiment of the invention will be described with reference to FIG. 1.

The controller 1 is configured to include a control unit 10 which controls various machines used for machining or the like and a PC unit 20 which provides a PC function for supporting a control operation of the control unit 10, supporting an operation of an operator, and the like.

The control unit 10 controls a machine (not shown), for example, by well-known numerical control or the like in the related art, and thus, the detailed description is omitted,

The PC unit 20 is configured to include a CPU 21 that is a processor performing a calculation process, a memory 22 such as a RAM or a ROM which is connected to the CPU 21 via a bus 29, a clock 23 which counts a time at a hardware level, a communication controller 24 which controls reception/transmission of data from/to the control unit 10, an input device controller 25 which controls an external input device 2, a storage device controller 26 which controls an external storage device 3, a display controller 27 which controls a display device 4, and a signal controller 28 which is used for controlling signals of the controller 1 from the PC unit 20.

When started up, the PC unit 20 provides the function of supporting the control operation of the control unit 10 and supporting the operation of the operator by reading a software program of an operating system (OS) from the external storage device 3 and operating various application software on the OS automatically or based on an external command under the control of the CPU 21. In the operation environment of applications installed on the OS, priority that defines order of priority of execution of each application software is prepared. A priority is designated to each application software at the time of execution, and when a plurality of the application software are simultaneously operated in a multi-tasking manner, the OS executes a task of an application having higher priority in preference to an applications having lower priority.

For example, in a case where tasks of application software of plural priority levels stand by in the state that the application software can be immediately executed when an execution right of the CPU 21 is acquired, the OS gives the execution right to the highest-priority task among the tasks of the application software. The task to which the execution right is given executes the process of the task. In a case where the contents of the process of the task proceed to a process (input/output process or the like) which does not use the CPU 21 or a case where a task of another higher-priority application software is in the state where the task can be immediately executed, the execution right of the CPU 21 by the task is returned to the OS, and the OS gives the returned execution right to the task of another higher-priority application software described above.

In this manner, management of the execution right is performed by the OS, so that a plurality of the application software are operated in parallel on the PC unit 20. If abnormality occurs in the process of the task of the application software, the task tries to continue to be executed in the abnormal state as it is. The OS gives the execution right to the task when it becomes possible to give the execution right to the task (in a state where a higher-priority task in the waiting state does not exist anymore). For this reason, in a case where abnormality occurs in the execution of a high-priority application, a low-priority application is forced to wait for the execution.

In the embodiment, a software timer executed by the application software is prepared for each level of priority. The software timers are configured so that the execution status thereof can be monitored from the outside, thereby allowing to identify a level of priority to which the application software where abnormality occurs belongs.

The operation state of the controller 1 will be described with reference to Fig, 2.

In the PC unit 20 of the controller 1, a hardware timer 210 implemented by a clock 23 (FIG. 1) is operating, and software timers 220a, 220b, . . . implemented by executing the application software are operating at the respective levels of priority.

The hardware timer 210 includes an internal counter (not shown). During the operation, the hardware timer performs counting by updating the internal counter every predetermined period (every clock period, every control period of the PC unit 20, or the like), and if the hardware timer operates for a predetermined time or by predetermined counter number, the hardware timer resets the internal counter and repeats the counting again.

In addition, when the hardware timer 210 is working, the hardware timer during-startup signal generation unit 230 generates a signal (a during-startup signal) indicating that the hardware timer 210 is in a state during startup and outputs the generated signal to an output unit 30. Here, ‘during-startup signal’ is a signal of which state regularly changes by counting of the hardware timer 210 and stops changing by stoppage of the hardware timer 210. The hardware timer during-startup signal generation unit 230 may be provided inside the hardware timer 210 or may be provided outside the hardware timer. Monitoring of the hardware timer 210 by the hardware timer during-startup signal generation unit 230 may be implemented, for example, by monitoring of the action of the internal counter of the hardware timer 210, or monitoring of the hardware timer 210 may be implemented by notifying the hardware timer during-startup signal generation unit 230 of the fact that the hardware timer 210 is working at the time of resetting the counter. In addition, the hardware timer during-startup signal generation unit 230 may output an ON signal, for example, as the during-startup signal, as long as the hardware timer 210 is working. Alternatively, the hardware timer during-startup signal generation unit 230 may output an ON signal and an OFF signal in a manner such that these ON and OFF signals are switched every time the internal counter of the hardware timer 210 indicates a predetermined. count value.

Similarly to the hardware timer 210, the software timers 220a, 220b, . . . include the respective counters (not shown) During the operation, the software timers perform counting by updating the internal counter every predetermined period (every clock period, every control period of the PC unit 20, or the like), and if the software timer operates for a predetermined time or by predetermined counter number, the software timers reset the internal counter and repeat the counting again.

In addition, when the software timers 220a, 220b, . . . are working, the software timer during-startup signal generation units 240a, 240b, . . . generate signals (during-startup signals) indicating that the software timers 220a, 220b, . . . , are each in a state during startup and output the generated signals to the output unit 30. The software timer during-startup signal generation units 240a, 240b, . . . may be provided inside the software timers 220a, 220b, . . . or may be provided outside the software timers 220a, 220b, . . . . Monitoring of the software timers 220a, 220b, . . . by the software timer during-startup signal generation units 240a, 240b, . . . may be implemented, for example, by monitoring of a memory in which values of the counters of the software timers 220a, 220b, . . . are stored, or such monitoring may be implemented by notifying the software timer during-startup signal generation units 240a, 240b, . . . of the fact that the software timers 220a, 220b, . . . are working at the time of resetting the counters. In addition, the software timer during-startup signal generation unit 240a, 240b, . . . may output an ON signal, for example, as the during-startup signal, as long as the software timer 220a, 220b, . . . are working Alternatively, the software timer during-startup signal generation units 240a, 240b, . . . may output an ON signal and an OFF signal in a manner such that these ON and OFF signals are switched every time the internal counter of each of the software timers 220a, 220b, . . . indicate a predetermined count value.

The output unit 30 outputs the signals which are output from the hardware timer during-startup signal generation unit 230 and the software timer during-startup signal generation units 240a, 240b, . . . and indicate that the respective timers are each in a state during startup, in a manner such that the signals can be observed from the outside. The output unit 30 may be configured such that, for example, LEDs corresponding to the during-startup signals of the respective timers are provided and the LEDs corresponding to the respective signals are turned ON or OFF in accordance with the states of the signals. In this case, the LEDs are arranged on an operation panel or the like of the controller, so that a worker at a working site can check the operation state of the PC unit 20 included in the controller 1. In addition, as another example of the configuration of the output unit 30, the during-startup signal of each timer may be configured to be encoded into data indicating the signal state, and the encoded data maybe output to an external monitoring device through a communication line or the like. In this case, the encoded data are received by the monitoring device or the like through the communication line, so that the operation state of the PC unit 20 included in the controller 1 can be centrally managed.

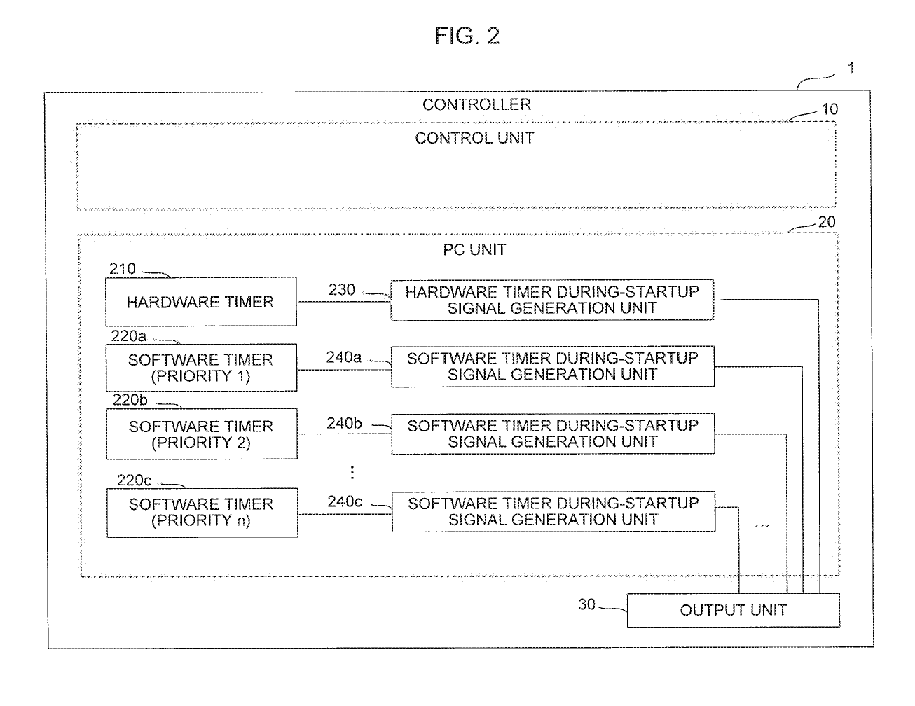

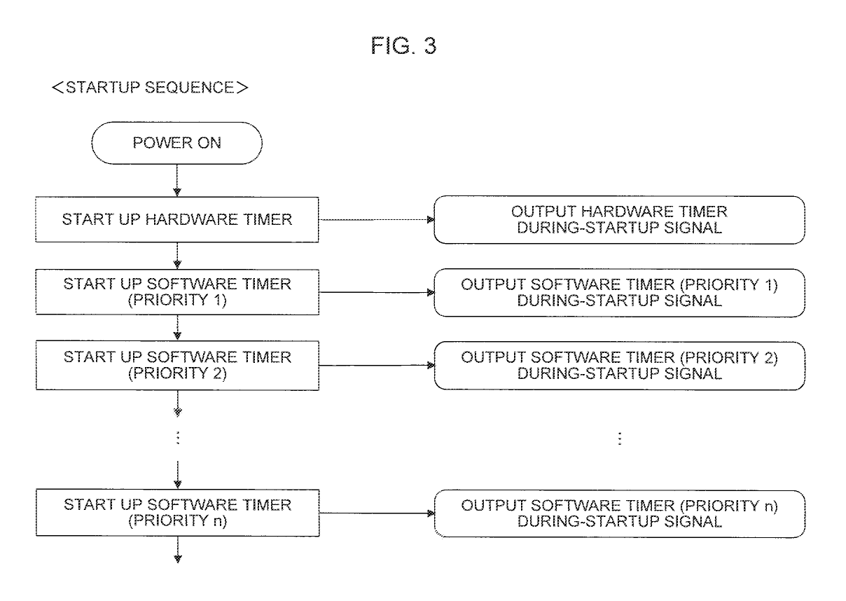

The operation state of the controller 1 illustrated. in FIGS. 1 and 2 will be described with reference to FIGS. 3 to 6.

First, the startup sequence of the controller 1 will be described with reference to FIG. 3.

If the controller 1 is powered ON, the hardware timer 210 is started up, If the startup of the hardware timer 210 is detected, the hardware timer during-startup signal generation unit 230 outputs the hardware timer during-startup signal, After that, the OS software is read from the external storage device 3 to the PC unit 20, and the OS is started up. By the OS, the application software of the software timers is executed by the respective levels of priority, and as a result, the software timers 220a, 220b, . . . are sequentially started up. If the startup of the software timers 220a, 220b, . . . is detected, the software timer during-startup signal generation units 240a, 240b, . . . output the during-startup signals of the respective software timers.

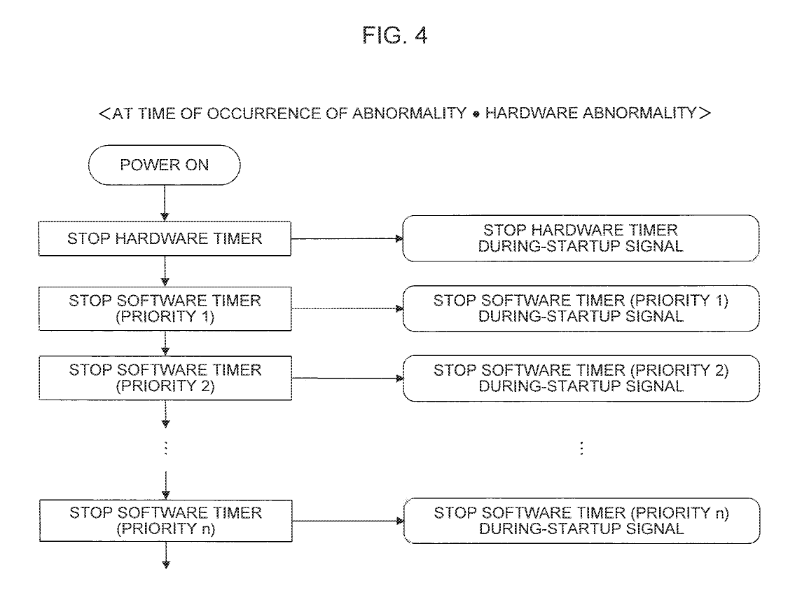

Next, when hardware abnormality occurs during the operation of the controller 1, the operation state will be described with reference to FIG. 4.

If the hardware abnormality occurs during the operation of the controller 1, all of the operation of the hardware timer 210 and the operations of the software timers 220a, 220b, . . . which are executed by respective levels of priority are stopped, For this reason, the hardware timer during-startup signal generation unit 230 and the software timer during-startup signal generation units 240a, 240b, . . . stop outputting the during-startup signals of the respective timers. Due to the stoppage of the during-startup signals of the respective timers, the outputting of the during-startup signals by the output unit 30 is also stopped. Therefore, for example, in a case where the during-startup signals are displayed by LEDs, turning-off, stoppage of flashing, or the like of all the LEDs is observed, so that it can be recognized that there is a problem at a hardware level.

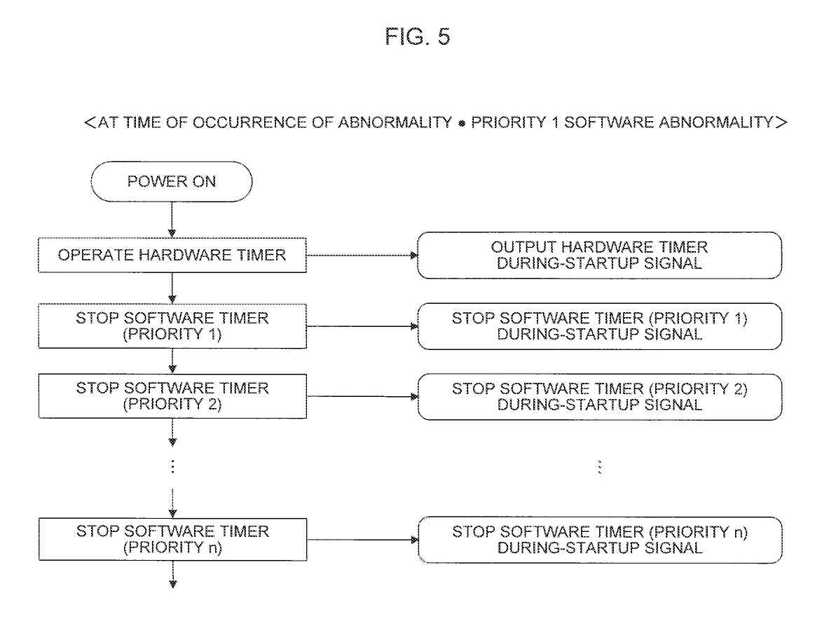

Next, when abnormality occurs in an application of a level of priority 1 during the operation of the controller 1, the operation state will be described with reference to FIG. 5.

If the abnormality occurs in the application which is working by the level of priority 1 during the operation of the controller 1, since the application continues to be in the executing state while the application is abnormal, the OS does not give the execution right to the task of other applications of levels which are equal to or lower than the level, so that operations of all the other applications are stopped. Since the software timers 220a, 220b, . . . are also included in the applications of which operations are stopped, all the operations of the software timers 220a, 220b, . . . of which levels are equal to or lower than the level of priority 1 are stopped, so that the software timer during-startup signal generation units 240a, 240b, . . . stop outputting the during-startup signals of the respective timers. Due to the stoppage of the during-startup signals of the respective software timers, the outputting of the during-startup signals of the respective software timers by the output unit 30 is also stopped. Therefore, for example, in a case where the during-startup signals are displayed by LEDs, turning-off, stoppage of flashing, or the like of all the LEDs excluding the LED corresponding to the hardware timer 210 is observed, so that it can be understood that there is no problem in the hardware, and furthermore, it can be recognized that there is a problem in the application of the level of priority 1.

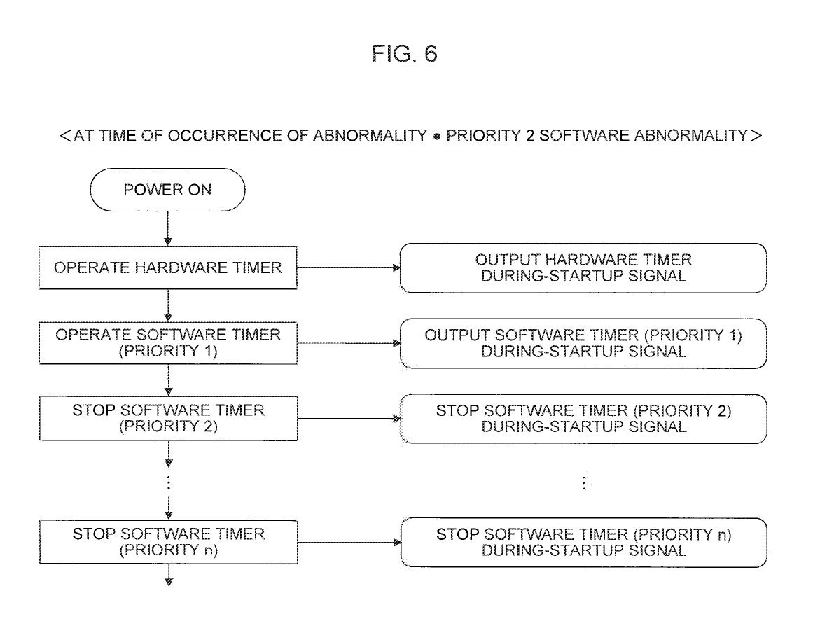

Next, when abnormality occurs in an application of a level of priority 2 during the operation of the controller 1, the operation state will be described with reference to FIG. 6.

If the abnormality occurs in the application which is working by the level of priority 2 during the operation of the controller 1, since the application continues to be in the executing state while the application is abnormal, the OS does not give the execution right to the task of other applications of levels which are equal to or lower than the level, so that operations of all the other applications are stopped. Since the software timers 220b, . . . are also included in the applications of which operations are stopped, all the operations of the software timers 220b, . . . of which levels are equal to or lower than the level of priority 2 are stopped, so that the software timer during-startup signal generation units 240b, . . . stop outputting the during-startup signals of the respective timers. Due to the stoppage of the during-startup signals of the respective software timers, the outputting of the during-startup signals of the respective software timers by the output unit 30 is also stopped. Therefore, in a case where the during-startup signals are displayed by LEDs, for example, turning-off, stoppage of flashing, or the like of all the LEDs excluding the LEDs corresponding to the hardware timer 210 and the software timer 220a is observed, so that it can be understood that there is no problem in the hardware, and furthermore, it can be recognized that there is a problem in the application of the level of priority 2.

Heretofore, while the embodiments of the invention are described, the invention is not limited to the above-described embodiments, the invention can be embodied in various forms by adding appropriate modifications.

1. A controller having a PC function, comprising:
a hardware timer that is configured with only hardware;
a software timer That performs counting by software;
a hardware timer during-startup signal generation unit that generates a hardware timer during-startup signal indicating that the hardware timer is in a state during startup;
a software timer during-startup signal generation unit that generates a software timer during-startup signal indicating that the software timer is in a state during startup; and
an output unit that outputs a state of the hardware timer during-startup signal and a state of the software timer during-startup signal.

2. The controller according to claim 1, wherein a plurality of the software timers are provided in accordance with priority, and each of the software timers includes the software timer during-startup signal generation unit.
